(19) United States
(12) Patent Application Publication
(10) Pub. No.: US 2007/0131516 A1
(43) Pub. Date: Jun. 14, 2007

(54) DEBRIS CAP FOR ROLLER-WAY CONVEYORS

(76) Inventor: Thomas Kordel, Liverpool (GB)

Correspondence Address: Intellectual Property Department;DEWITT ROSS & STEVENS, S.C., Firstar Financial Centre, 8000 Excelsior Drive, Suite 401, Madison, WI, 53717-1914, US

(21) Appl. No.: 11/566,372

(22) Filed: Dec. 4, 2006

(30) Foreign Application Priority Data
Dec. 5, 2005 (GB) GB 0524792.9

(51) Int. Cl. B65G 13/00

(52) U.S. Cl. 193/37

(57) ABSTRACT

There is disclosed a debris cap for roller-way conveyors. The debris cap closes off the ends of a channel-shaped body, thus preventing debris inside the channel-shaped body from escaping the ends. The debris cap has a pair of side arms with recesses for engaging with a roller-bearing axle. A floor of the debris cap substantially forms a seal with the bottom of the channel-shaped body, thus closing off the ends of the channel-shaped body.

### FIELD OF THE INVENTION

The present invention relates to roller-way conveyors and, more particularly but not exclusively, to single roller-way conveyors.

### BACKGROUND OF THE INVENTION

Roller-way conveyors are known for material handling inside, for example, lorries or aircraft. An example of a roller-way conveyor is known from GB 2378692 which shows a double roller-way conveyor (a double roller-way conveyor is a roller-way conveyor having two rollers per axle).

Some types of retractable roller-way conveyors use an air bag to raise or lower a channel-shaped body which supports the rollers. When an air bag is deflated, the channel-shaped body is lowered and the rollers are retracted below a support surface, thereby allowing cargo items carried by the rollers to rest on a support surface (the support surface is provided with apertures to allow the rollers to project through the support surface). When the air bag is inflated, the channel-shaped body is raised, causing the rollers to project through the apertures in the support surface and thus lifting cargo items off the support surface, thereby enabling the cargo items to be slid over the rollers.

In such roller-way conveyors, debris can pass through gaps between the apertures and the rollers. Any such debris will come to rest in the channel-shaped body and, due to vibration, may travel to an end of the channel-shaped body, exit the channel-shaped body, and come into contact with the air bag, eventually puncturing the air bag.

### BRIEF DESCRIPTION OF THE DRAWINGS

FIG. 1 shows a perspective view of a debris cap mounted to a channel-shaped body.

FIG. 2 shows a perspective view of the debris cap of FIG. 1.

FIG. 3a shows a debris cap being clipped to a roller axle.

FIG. 3b shows the roller cap after being rotated around the roller axle, and abutting a channel-shaped body.

FIG. 4 shows a web that may be folded to produce the debris cap of FIG. 1.

FIG. 5 shows, in a view corresponding to FIG. 3b, an alternative embodiment of a debris cap.

### DETAILED DESCRIPTION OF PREFERRED VERSIONS OF THE INVENTION

The present invention, which is defined by the claims set forth at the end of this document, seeks to overcome disadvantages with prior art roller-way conveyors. In particular, the present invention seeks to allow prior art roller-way conveyors to be modified by retrofitting so as to reduce problems with debris causing air bag puncture. As well as reducing the effect of debris, another advantage of the present invention is that is can be retrofitted to a roller-way conveyor without requiring the rollers or axles to be removed from the channel-shaped body.

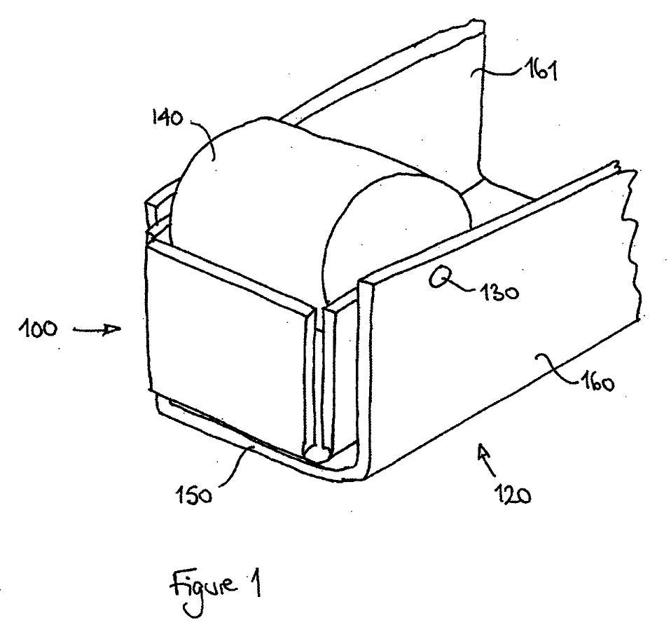

FIG. 1 shows a debris cap 100 mounted to a channel-shaped body 120. An axle 130 is mounted to the channel-shaped body 120 and supports a roller 140. The channel-shaped body 120 has a generally “U” shaped cross-sectional profile including upstanding sidewalls 160, 161 and a bottom 150 between the sidewalls 160, 161. The debris cap 100 fits between the sidewalls 160, 161 of the channel-shaped body 120.

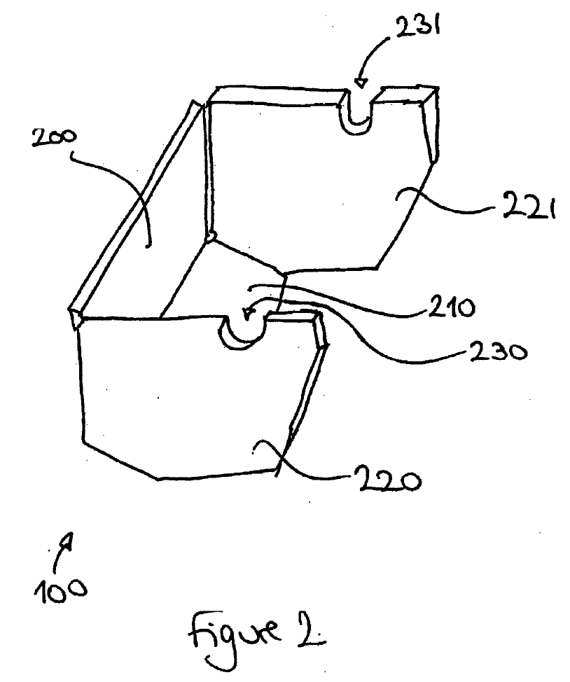

FIG. 2 shows a perspective view of the debris cap 10 of FIG. 1. The debris cap 100 has a back 200, a floor 210 and two side arms 220, 221 having respective recesses 230, 231.

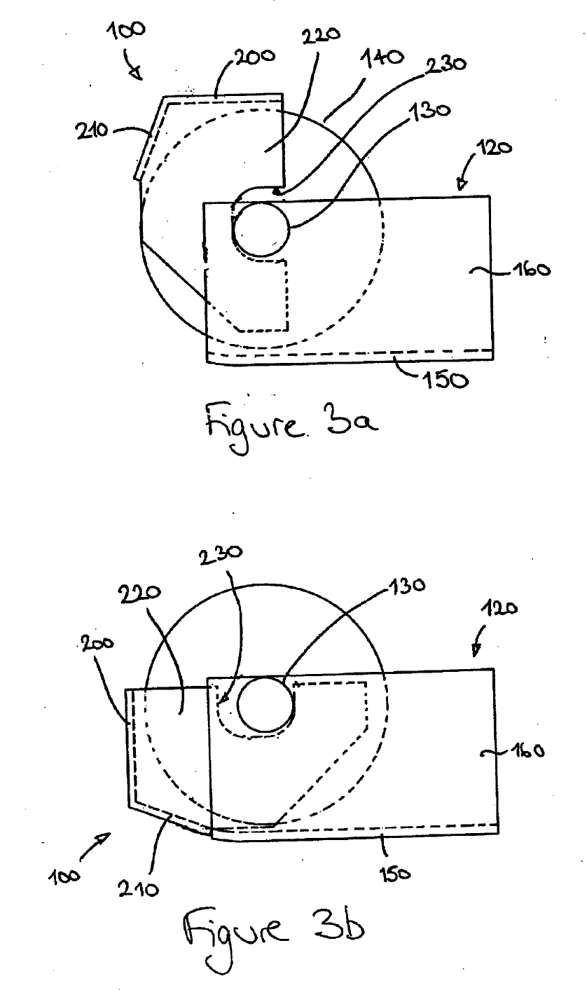

FIG. 3a shows the debris cap 100 being clipped to an axle 130 as part of a method of mounting the debris cap 100 to the channel-shaped body 120. With the back 200 of the debris cap 100 being held uppermost and in a horizontal plane, the debris cap 100 is moved relative to the longitudinal axis of the channel-shaped body 120 so that the ends of the axle 130 are received by the recesses 230, 231. The debris cap 100 is then rotated around the axle 130.

FIG. 3b shows the debris cap 100 after rotation around the axle 130. The back 200 of the debris cap 100 is now in a vertical plane. An edge of the floor 210 of the debris cap 100 abuts an edge of the bottom 150 of the channel-shaped body 120. In this embodiment, the floor 210 is angled by 20 degrees relative to the bottom 150 of the channel-shaped body 120. Thus debris inside the channel-shaped body 120 can no longer fall out of the end of the channel-shaped body 120 (and towards an air bag, not shown) as debris is prevented from doing so by the back 200 and floor 210. The recesses 230, 231 engage with the axle 130 to prevent movement of the debris cap 100 relative to the longitudinal axis of the channel-shaped body 120.

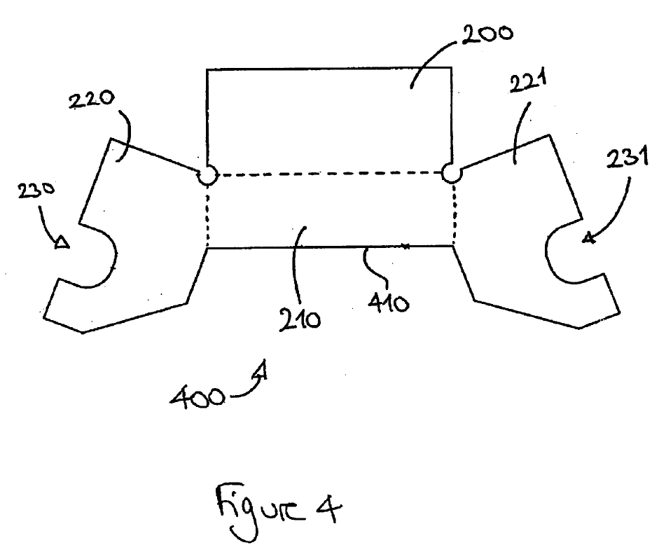

FIG. 4 shows a web 400 that may be folded to produce the debris cap 100 of FIG. 1. Phantom lines are used to delimit the portions of the web 400 that form the back 200, floor 210, side arms 220, 221 and recesses 230, 231. In this embodiment, the web 400 is mild steel.

In FIG. 4, an edge 410 of the portion of the web 400 that forms the floor 210 has been denoted by the reference sign 410. With reference to FIG. 3b, it is the edge 410 of the floor 210 that abuts the edge of the bottom 150 of the channel-shaped recess 120. Also in FIG. 4, edges 420, 421 of the portions of the web 400 that form the side arms 220, 221 are denoted by the reference signs 420, 421. With reference to FIG. 3b, it can be seen that the edges 420, 421 are parallel to the bottom 150 of the channel-shaped body 120 and are spaced apart from the bottom 150 of the channel-shaped body 120.

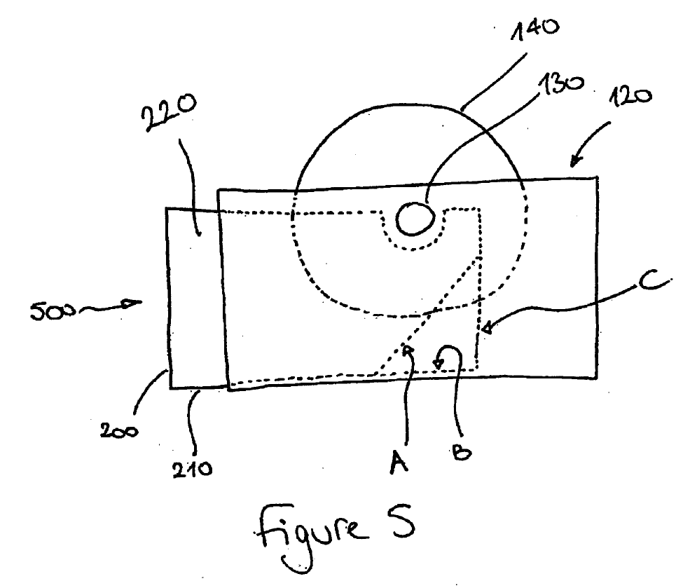

An alternative embodiment of a debris cap is shown at FIG. 5. In this embodiment, the debris cap 500 is arranged so that, in use, the floor 210 lies against and parallel to the bottom 150 of the channel-shaped body 120. In this embodiment, the side arms 220, 221 terminate at line “A”. In a further embodiment, the side arms 220, 221 terminate at lines “B” and “C” instead of at line “A”. For the further embodiment, the floor 210 does not lie parallel to the bottom 150 of the channel-shaped body 120; this is because further rotation of the debris cap about the axle 130 is prevented by the portion of the side arms 220, 221 at the intersection of lines “B” and “C”. Thus for the further embodiment, the moment of the debris cap 500 about the axle 130 urges, due to gravity, the portion of the side arms 220, 221 at the intersection of the lines “B” and “C” into continual contact with the bottom 150 of the channel-shaped body 120.

In another embodiment, not shown, the axle 120 protrudes at each end beyond the upstanding sidewalls 160, 161 of the channel-shaped body 120. This allows an alternative embodiment, not shown, of the debris cap to be fixed around the exterior of the channel-shaped body 120 (in contrast, it will be recalled from FIG. 1 that there the debris cap 100 was fitted in between the upstanding sidewalls 160, 161 of the channel-shaped body 120). In such an embodiment, the floor 120 of the debris cap will engage with the exterior surface rather than the interior surface of the bottom 150 of the channel-shaped body 120.

In embodiments shown above, a pair of side arms 220, 221 were used. In alternative embodiments, a single side arm 220 is used instead of a pair. As the skilled man will appreciate, suitable modifications may be made to the shape of such a debris cap in order to control the yaw, pitch and roll of the debris cap relative to the channel-shaped body 120.

In embodiments shown above, the debris caps has both a back 200 and a floor 210. In alternative embodiments, debris caps may have only a floor 210; provided the floor 210 is angled sufficiently upwards relative to the bottom of the channel-shaped body 120 then debris will not be able to escape the channel-shaped body 120. In yet further embodiments the floor 210 may be extended away from the recesses 230, 231 so that the floor 120 acts, in effect, as a back 200.

With reference to FIG. 4, in some embodiments the edge 410 may be fitted with a rubber seal (not shown) to form a seal with the channel-shaped body 120. In some situations the rubber seal may be used to further reduce the amount of debris which comes into contact with the air bag (not shown).

FIG. 4 shows a web 400 for forming a debris cap from corrosion protected sheet steel. In alternative embodiments, thicker material may be used, provided that the side arms 220, 221 are made sufficiently thin to pass through the gap between the roller 140 and the inside surfaces of the upstanding sidewalls 160, 161 of the channel-shaped body 120.

In embodiments described above, the bottom 150 of the channel-shaped body 120 was generally flat and arranged in a horizontal plane. In alternative embodiments, the bottom 150 of the channel-shaped body may be non-planar and may, for example, be shaped as a “V”. Such roller-way conveyors may require a corresponding modification to the floor of the debris cap (for example to a “V” shape”) so that the floor of the debris cap conforms to the bottom of the channel-shaped body 120. The fit between the floor of the debris cap and the bottom of the channel-shaped body need not be perfect although a good fit is preferred as a gap between the floor and bottom may allow debris particles smaller than the gap to pass through the gap and towards an air bag.

Furthermore, the floor of the debris cap and the bottom of the channel-shaped body 120 need not have the same shape, provided that the size of a gap is minimized. For example, suppose that the bottom of the channel-shaped body 120 has a “V” shape. In an alternative embodiment, a debris cap having a planar floor may be used to close off the “V” shaped end of the channel-shaped body 120. In such an embodiment, the debris cap is arranged so that the floor, when adjacent the bottom, is in a generally vertical plane and thus is in the same plane as the “V” of the channel-shaped body 120 (in contrast, FIG. 3b shows an arrangement in which the floor 210 was only inclined about 20 degrees up from horizontal).

In one embodiment, the debris cap 100 closes off the ends of a channel-shaped body 120, thus preventing debris inside the channel-shaped body 120 from escaping the ends. The debris cap 100 gas a pair of side arms 220, 221 with recesses 230, 231 for engaging with an axle 130 (the axle 130 holds a roller 140). A floor 120 of the debris cap 100 substantially forms a seal with the bottom 150 of the channel-shaped body 120, thus closing off the ends of the channel-shaped body 120.

It is understood that preferred versions of the invention have been described above in order to illustrate how to make and use the invention. The invention is not intended to be limited to these versions, but rather is intended to be limited only by the claims set out below. Thus, the invention encompasses all different versions that fall literally or equivalently within the scope of these claims.

What is claimed is:

1. A debris cap for a roller-way conveyor, comprising:
a. at least one side arm, each side arm having a recess for receiving an axle; and
b. a floor adjacent the side arm for engaging a bottom of a channel-shaped body.

2. The cap of claim 1 wherein there are two of the side arms.

3. The cap of claim 2 comprising a back:
a. extending from the floor, and
b. between the side arms.

4. The cap of claim 1 wherein the cap is formed from an at least substantially planar web.

5. The cap of claim 1 wherein the floor includes an elastomeric portion suitable for engaging with the bottom of the channel-shaped body.

6. The cap of claim 1 in combination with a roller-way conveyor, the roller-way conveyor comprising:
a. a channel-shaped body;
b. an axle; and
c. a roller,
wherein the recess of each side arm receives the axle, and wherein the floor is engaged with the bottom of the channel-shaped body.

7. The cap of claim 6 wherein:
a. the debris cap has a moment about the axle, and
b. the moment urges the floor against the bottom of the channel-shaped body.

8. The cap of claim 7 wherein an edge of the floor abuts an edge of the bottom of the channel-shaped body.

9. The cap of claim 6 wherein the roller-way conveyor comprises a single roller per axle.

10. The cap of claim 6 comprising an air bag for moving the channel-shaped body.

11. The cap of claim 6 wherein the debris cap is received inside the channel-shaped body.

12. The cap of claim 6:
a. wherein the debris cap is at a first end of the channel-shaped body, and
b. further comprising a second debris cap at a second end of the channel-shaped body opposite the first end.

13. The cap of claim 6 further comprising a vehicle wherein the roller-way conveyor is mounted.

14. The cap of claim 13 wherein the vehicle is a lorry.

15. A method of fitting a roller-way conveyor with a debris cap wherein:
A. the roller-way conveyor comprises:
1. a channel-shaped body;
2. an axle; and
3. a roller;
B. the debris cap comprises:
1. at least one side arm, each side arm having a recess for receiving the axle; and
2. a floor adjacent the side arm for engaging a bottom of the channel-shaped body;
the method comprising the steps of:
a. engaging a recess with the axle;
b. rotating the debris cap around the axle until the floor engages the bottom of the channel-shaped body.

16. A debris cap for a roller-way conveyor comprising:
a. a floor having a pair of opposing lateral edges;
b. a pair of side arms, each side arm:
(1) extending at least substantially perpendicularly from one of the lateral edges of the floor, and
(2) being bounded by an edge, wherein the edge has a recess defined therein for receiving an axle, the recess being situated generally opposite the floor.

17. The debris cap of claim 16 in combination with a roller-way conveyor wherein:
a. the roller-way conveyor includes:
(1) a body having a pair of opposing sidewalls with a bottom extending therebetween, the sidewalls and bottom defining a channel;
(2) an axle extending between the sidewalls, the axle having a roller thereon;
b. the debris cap is mounted on the roller-way conveyor with:
(1) the recesses of the side arms receive the axle therein, and
(2) the floor of the debris cap rests adjacent the bottom of the body.

18. The debris cap of claim 17 wherein the debris cap further includes a back, the back extending between the side arms adjacent the floor.
